(19) United States
(12) Patent Application Publication
(10) Pub. No.: US 2007/0298206 A1
(43) Pub. Date: Dec. 27, 2007

(54) DIGITAL MEDIA CREATED USING ION BEAM TECHNOLOGY

(76) Inventors: Charles Marshall, Burbank, CA (US); John A. Trepl II, Dana Point, CA (US); Roger A. Kuntz, Laguna Niguel, CA (US); Axel M. Kuntz, Lake Forest, CA (US)

Correspondence Address: Zilka-Kotab, PC, P.O. BOX 721120, SAN JOSE, CA, 95172-1120, US

(21) Appl. No.: 11/769,263

(22) Filed: Jun. 27, 2007

Related U.S. Application Data
(63) Continuation of application No. 10/955,025, filed on Sep. 29, 2004.
(63) Continuation-in-part of application No. 10/934,234, filed on Sep. 3, 2004.

(51) Int. Cl. B32B 3/02

(52) U.S. Cl. 428/64.4

(57) ABSTRACT

An optical medium including an underlayer and a reflective layer, where at least one of the underlayer and the surface layer has surface features thereon representing data, the surface features having been formed by directing pulses of a beam of ions from an ion source onto at least one of the underlayer and the reflective layer in a controlled pattern for creating the surface features

### RELATED APPLICATIONS

This application is a continuation of U.S. patent application Ser. No. 10/955,025 filed Sep. 29, 2004, and a continuation-in-part of copending U.S. patent application Ser. No. 10/934,234 filed Sep. 3, 2004.

### FIELD OF THE INVENTION

The present invention relates to digital media and more particularly, this invention relates to digital media manufactured using ion beam technology.

### BACKGROUND OF THE INVENTION

Optical media presently include compact discs (CDs), digital video discs (DVDs), laser discs, and specialty items. Optical media has found great success as a medium for storing music, video and data due to its durability, long life, and low cost.

A CD typically comprises an underlayer of clear polycarbonate plastic. During manufacturing, the polycarbonate is injection molded against a master having protrusions (or pits) in a defined pattern that creates an impression of microscopic bumps arranged as a single, continuous, spiral track of data on the polycarbonate. Then, a thin, reflective aluminum layer is sputtered onto the disc, covering the bumps. Next a thin acrylic layer is sprayed over the aluminum to protect it. A label is then printed onto the acrylic. FIG. 1 illustrates a cross section of a typical data or audio CD 100, particularly depicting the polycarbonate layer 102, aluminum layer 104, acrylic layer 106, label 108, and pits 110 and lands 112 that represent the data stored on the CD 100. Note that the “pits” 110 are as viewed from the aluminum side, but on the side the laser reads from, they are bumps. The elongated bumps that make up the data track are each 0.5 microns wide, a minimum of 0.83 microns long and 125 nanometers high. The dimensions of a standard CD is about 1.2 millimeters thick and about 4.5 inches in diameter. A CD can hold about 740 MB of data.

During playback, the reader's laser beam passes through the polycarbonate layer, reflects off the aluminum layer and hits an opto-electronic device that detects changes in light. The bumps reflect light differently than the lands, and an opto-electronic sensor detects that change in reflectivity. The electronics in the reader interpret the changes in reflectivity in order to read the bits that make up the data.

The data stored on the CD is retrieved by a CD player that focuses a laser on the track of bumps. The laser beam passes through the polycarbonate layer, reflects off the aluminum layer and hits an opto-electronic device that detects changes in light. The bumps reflect light differently than the lands, and the opto-electronic sensor detects that change in reflectivity. The electronics in the drive interpret the changes in reflectivity in order to read the bits that make up the bytes.

A DVD is very similar to a CD, and is created and read in generally the same way (save for multilayer DVDs, as described below). However, a standard DVD holds about seven times more data than a CD.

Single-sided, single-layer DVDs can store about seven times more data than CDs. A large part of this increase comes from the pits and tracks being smaller on DVDs. Table 1 illustrates a comparison of CD and DVD specifications.

TABLE 1

| Specification | CD | DVD |
|---|---|---|
| Track Pitch | 1600 nanometers | 740 nanometers |
| Minimum Pit Length | 830 nanometers | 400 nanometers |
| (single-layer DVD) | | |
| Minimum Pit Length | 830 nanometers | 440 nanometers |
| (double-layer DVD) | | |

To increase the storage capacity even more, a DVD can have up to four layers, two on each side. The laser that reads the disc can actually focus on the second layer through the first layer. Table 2 lists the capacities of different forms of DVDs.

TABLE 2

| Format | Capacity | Approx. Movie Time | |
|---|---|---|---|
| Single-sided/single-layer | 4.38 GB | 2 | hours |
| Single-sided/double-layer | 7.95 GB | 4 | hours |
| Double-sided/single-layer | 8.75 GB | 4.5 | hours |
| Double-sided/double-layer | 15.9 GB | Over 8 | hours |

A DVD is composed of several layers of plastic, totaling about 1.2 millimeters thick. FIG. 2 depicts the cross section of a single sided/double-layer DVD 200. Each layer is created by injection molding polycarbonate plastic against a master, as described above. This process forms a disc 200 that has microscopic bumps arranged as a single, continuous and extremely long spiral track of data. Once the clear pieces of polycarbonate 202, 204 are formed, a thin reflective layer is sputtered onto the disc, covering the bumps. Aluminum 206 is used behind the inner layers, but a semi-reflective gold layer 208 is used for the outer layers, allowing the laser to focus through the outer and onto the inner layers. After all of the layers are made, each one is coated with lacquer, squeezed together and cured under infrared light. For single-sided discs, the label is silk-screened onto the nonreadable side. Double-sided discs are printed only on the nonreadable area near the hole in the middle. Cross sections of the various types of completed DVDs (not to scale) look like this

A DVD player functions similarly to the CD player described above. However, in a DVD player, the laser can focus either on the semi-transparent reflective material behind the closest layer, or, in the case of a double-layer disc, through this layer and onto the reflective material behind the inner layer. The laser beam passes through the polycarbonate layer, bounces off the reflective layer behind it and hits an opto-electronic device, which detects changes in light.

One problem with each of these technologies is that it is very expensive and time consuming to create the master. Another problem is that if the master is not perfectly formed, none of the discs created from it will work properly. Further, as shown in FIG. 3A, the bumps 302 on the master 300 must be beveled so that the polycarbonate 304 releases from the master 300. This beveling places limits on the size of the surface features, as reading ability is reduced as the amount of beveling moves from 90 degrees.

Another problem is that the ends 306 of the bumps 302 of the master are also rounded, as shown in FIG. 3B, to aid in separation of the master 300 from the polycarbonate 304. However, the rounded edge causes jitter during the playback. In fact, >50% of jitter can be attributed to the rounded edges.

CDs and DVDs also come in the form of recordable discs. CD-recordable discs (CD-Rs) and DVD-recordable discs (DVD±Rs), do not have any bumps or flat areas (pits or lands). Instead, as shown on the cross section of a recordable disc 400 in FIG. 4, they have a smooth reflective metal layer 402, which rests on top of a layer of photosensitive dye 404, a layer of polycarbonate 406 under the dye, and a backing layer 408. When the disc is blank, the dye is translucent: light can shine through and reflect off the metal surface. The write laser darkens the spots 410 where the bumps would be in a conventional CD or DVD, forming non-reflecting areas. This is known as “burning” a disc. By selectively darkening particular points 410 along the data track, and leaving other areas of dye translucent, a digital pattern is created that is readable by a standard CD or DVD player. The light from the player's laser beam will only bounce back to the sensor when the dye is left translucent, in the same way that it will only bounce back from the flat areas of a conventional CD or DVD.

In place of the CD-R and DVD-R disc's dye-based recording layer, CD-RW and DVD±RW use a crystalline compound made up of a mix of silver, indium, antimony and tellurium. When this combination of materials is heated to one temperature and cooled it becomes an optically transmissive crystalline, but if it is heated to a higher temperature, when it cools down again it becomes amorphous and thus optically opaque. The crystalline areas allow the reflective layer to reflect the laser better while the non-crystalline portion absorbs the laser beam, so it is not reflected.

In order to achieve these effects in the recording layer, the disc recorder use three different laser powers: the highest laser power, which is called “Write Power”, creates a non-crystalline (absorptive) state on the recording layer; the middle power, also known as “Erase Power”, melts the recording layer and converts it to a transmissive crystalline state; and the lowest power, which is “Read Power”, does not alter the state of the recording layer, so it can be used for reading the data.

During writing, a focused “Write Power” laser beam selectively heats areas of the phase-change material above the melting temperature (500-700° C.), so all the atoms in this area can move rapidly in the liquid state. Then, if cooled sufficiently quickly, the random liquid state is “frozen-in” and the so-called amorphous state is obtained. The amorphous version of the material becomes opaque where the laser dot was written, resulting in a recognizable CD or DVD surface. When an “Erase Power” laser beam heats the phase-change layer to below the melting temperature but above the crystallization temperature (200° C.) for a sufficient time (at least longer than the minimum crystallization time), the atoms revert back to an optically transmissive ordered state (i.e., the crystalline state). Writing takes place in a single pass of the focused laser beam; this is sometimes referred to as “direct overwriting” and the process can be repeated several thousand times per disc.

One problem with recordable optical media is that burning takes a long time, making replication of discs by this method very inefficient. For example, it takes over 2 minutes to burn a 640 MB CD-R at 48× normal read speed. It takes 14-16 minutes to burn a single side, single layer DVD±R. These times do not include the other processing time, such as the time it takes to open the drive door, load the disc, close the door, initiate the drive, then after burning open the door, remove the disc, etc.

Another problem with recordable media is that the writing laser inherently produces dye spots with rounded edges. As mentioned above, rounded edges create jitter.

What is therefore needed is a way to improve the write speed for optical media.

What is also needed is a way to create a clean edge between reflective and nonreflective lands and pits so that the reflected laser is better controlled.

What is further needed is a way to write media in a way that the surface features have enhanced edge characteristics.

### SUMMARY OF THE INVENTION

An optical medium according to one embodiment includes an underlayer and a reflective layer, where at least one of the underlayer and the surface layer has surface features thereon representing data, the surface features having been formed by directing pulses of a beam of ions from an ion source onto at least one of the underlayer and the reflective layer in a controlled pattern for creating the surface features.

If the optical medium is a disc, the pattern preferably has a generally spiral shape. In one embodiment, the medium comprises a substantially transparent underlayer and a reflective layer, the ion pulses modifying the reflective layer. In another embodiment, the medium comprises an underlayer and a reflective layer, the ion pulses creating pits in the underlayer, the reflective layer preferably being added after the surface features are created. In a further embodiment, the medium comprises a reflective layer, and a dye underlayer being substantially transparent in an unexposed state, the ion pulses creating darkened portions (surface features) on the dye layer. In a still further embodiment, the medium comprises a reflective layer, and a dye underlayer being substantially nontransparent in an unexposed state, the ion pulses creating substantially transparent portions on the dye layer. In yet another embodiment, the surface features are created on at least two layers of the optical medium, as in a double layer DVD.

A system for performing this method, according to one embodiment, includes a medium receiving portion for holding an optical medium, an ion source such as an ion gun for emitting a beam of ions at the optical medium on the medium receiving portion, and a steering mechanism for directing the ion beam onto the optical medium in a controlled manner. The beam of ions strikes the optical medium in intermittent pulses for creating surface features on the optical medium, the surface features representing data.

The system described herein can write data such as audio data, video data, software, etc. to an optical medium very quickly, e.g., in less than one minute, and even in less than one second. The system is able to write data to any type of optical media, including those readable by consumer-grade CD and DVD players. Suitable optical media include any type of commercially available medium, including CD, DVD, laser disc, recordable discs (e.g., CD-R, CD-RW, DVD+R, DVD-R, DVD+RW, DVD-RW), or any type of medium from which data is read optically.

By controlling the power and width of the pulses, the system can create surface features readable by current optical media readers as well as proprietary readers. In any of these methods, the surface features can be made significantly smaller than has heretofore been possible, even using commercially available media. This is due to the fine detail (e.g., ˜5 nanometer) and sharp edges afforded by ion beam technology. For instance, the surface features can have a length along a data track thereof of less than about 500 nanometers, less than about 200 nanometers, less than about 100 nanometers, and less than about 50 nanometers. In this way, the data storable on a single medium can be greatly improved, limited only by the wavelength of the optical system used. For finer surface features, for example, ultraviolet, microwave and x-ray optical systems may be required.

The beam can be directed in the controlled pattern via magnetic fields generated by steering coils. In one embodiment, the pulses are generated by controlling a grid voltage of the ion source. In another embodiment, the pulses are generated by beam blanking.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a partial cross sectional view, not to scale, of a CD.

FIG. 2 is a partial cross sectional view, not to scale, of a single sided, dual-layer DVD.

FIG. 3A is a partial cross sectional view, not to scale, of a master and polycarbonate layer.

FIG. 3B is a partial cross sectional view, not to scale, taken along line 3B-3B of FIG. 3A.

FIG. 4 is a partial cross sectional view, not to scale, of a recordable medium.

FIG. 5 is a representative system diagram of a system for writing data to an optical medium according to one embodiment.

FIG. 6 is a flow diagram of a method for writing data to a standard CD or a single or double sided, single layer (per side) DVD according to an illustrative embodiment.

FIG. 7 is a flow diagram of a method for writing data to a CD or a single or double sided, single layer (per side) DVD according to an illustrative embodiment.

FIG. 8 is a flow diagram of a method for writing data to a single sided, double layer (per side) DVD according to an illustrative embodiment.

FIG. 9 is a flow diagram of a method for writing data to a recordable disc, such as a commercially available recordable CD or DVD according to an illustrative embodiment.

FIG. 10 is a side view of a surface feature created by an ion beam.

FIG. 11A-B is a partial cross sectional view, not to scale, of another embodiment of an optical medium.

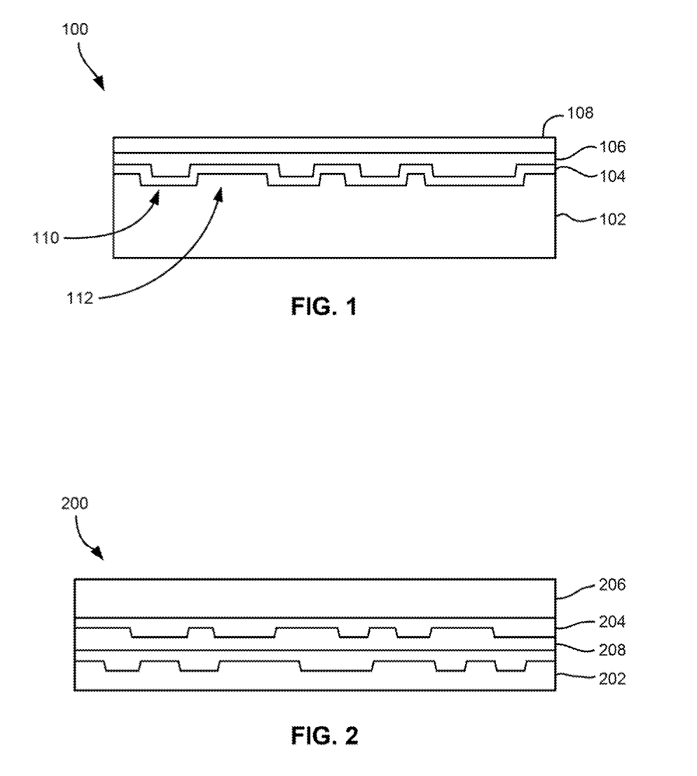

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein.

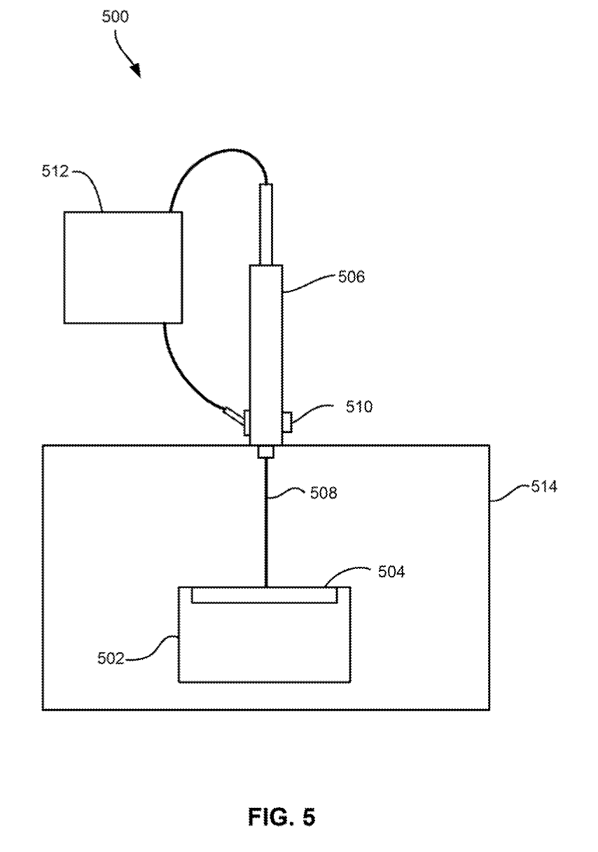

FIG. 5 illustrates a system 500 for writing data to an optical medium according to one embodiment. The system 500 includes a medium receiving portion 502 for holding a target optical medium 504, an ion source 506 such as an ion gun for emitting a beam of ions 508 at the optical medium on the medium receiving portion 502, and a steering mechanism 510, which may be integral with the gun 506, for directing the ion beam 508 onto the optical medium 504 in a controlled manner such as in a spiral, concentric circles, straight lines, etc. A controller 512 controls operation of the system components. The beam of ions 508 is made to strike the optical medium 504 intermittently so that surface features are created on the optical medium 504. Particularly, the ion beam 508 displaces or oblates the material it strikes, creating pits. This process is generally referred to as milling, etching or sputtering. The resultant pits and lands along the data track represent data. At least the medium receiving portion 502 should be positioned in a vacuum chamber 514 maintained at a vacuum of 1×10⁻³ Torr or below. Note that the emitting portion of the gun 506 should also be positioned in the vacuum chamber 514.

The system described herein can write data such as audio data, video data, software, etc. to an optical medium very quickly, e.g., in less than one minute, and even in less than one second. The system is able to write data to any type of optical media, including those readable by consumer-grade CD and DVD players. Suitable optical media include any type of commercially available medium, including CD, DVD, laser disc, recordable discs (e.g., CD-R, CD-RW, DVD+R, DVD-R, DVD+RW, DVD-RW), or any type of medium from which data is read optically. Of course, the technology disclosed herein would extend to future types of optical media that are presently under development or have yet to be discovered.

The system of the present invention can incorporate therein a positive ion source or a negative ion source. Illustrative ion species which perform the bombardment are Ar+, O2+, Ga+, Gs+, Li+, Na+, K+, Rb+, etc.

A preferred embodiment implements a Focused Ion Beam (FIB) system. A FIB system takes charged particles from a source, focuses them into a beam through electromagnetic/electrostatic lenses, and then scans across small areas of the target using deflection plates or scan coils. The FIB system produces high resolution imaging by collecting the secondary electron emission produced by the beam's interaction with the target surface. Contrast is formed by raised areas of the sample (hills) producing more secondary electrons than depressed areas (valleys).

In a preferred embodiment, the FIB system uses gallium ions from a field emission liquid metal ion (FE-LMI) source. In operation, a gallium (Ga⁺) primary ion beam hits the sample surface and sputters a small amount of material, the displaced material leaving the surface as either secondary ions (i⁺ or i⁻) or neutral atoms (n⁰). The primary ion beam also produces secondary electrons (e−). As the primary beam rasters on the sample surface, the signal from the sputtered ions or secondary electrons is collected to form an image.

At low primary beam currents, very little material is sputtered; modern FIB systems can achieve 5 nm imaging resolution. At higher primary currents, a great deal of material can be removed by sputtering, allowing precision milling of the specimen down to a sub-micron scale. One test by the inventors on commercial media results in a 40 nm image resolution.

Many variables and material properties affect the sputtering rate of a sample. These include beam current, sample density, sample atomic mass, and incoming ion mass. A preferred ion species is Ga+.

Additionally, gas-assisted etching can be used. When a gas is introduced near the surface of the sample during milling, the sputtering yield can increase depending on the chemistry between the gas and the sample. For instance, by injecting a reactive gas into the mill process, the aspect ratio of the ion beam's cutting depth can be dramatically altered such that it is possible to reach the lower metallization line without disturbing the upper layer metallization. This results in less redeposition and more efficient milling. Two typical gasses are iodine and xenon difluoride.

If the sample is non-conductive, a low energy electron flood gun can be used to provide charge neutralization. In this manner, by imaging with positive secondary ions using the positive primary ion beam, even highly insulating samples may be imaged and milled without a conducting surface coating, as would be required in a SEM. This feature is particularly useful for writing surface features directly to the polymeric layer of an optical medium.

Suitable ion guns include the ILG-2, IGPS-2, E/IMG-16, E/IGPS-16, available from Kimball Physics, 311 Kimball Hill Road, Wilton, N.H. 03086-9742 USA. Another suitable ion gun is the IOG 25 Gallium Liquid Metal Ion Gun, available from Ionoptika Ltd, Epsilon House, Chilworth Science Part, Southampton, Hampshire SO16 7NS, UK. One skilled in the art will recognize that there are several manufacturers of ion guns that are also suitable for use with the system, including those having larger and smaller spot sizes.

The steering mechanism can use rastering technology to aim the ion beam at the optical medium along the data path. One preferred steering mechanism includes steering coils or deflection plates under control of the controller. Steering coils are copper windings that create magnetic fields that affect the direction of the ion beam. One set of coils creates a magnetic field that moves the ion beam in the X direction, while another set moves the beam in the Y direction. The deflection plate assembly consists of two pairs (X and Y) of deflection plates located near the beam-exit end of the gun. Potentials applied to these plates produce a deflecting force in a plane perpendicular to the direction of beam travel. By controlling the voltages in the coils or plates, the ion beam can be positioned at any point on the medium. Because rastering can be performed very quickly, a full data track can be transferred to the optical medium in a fraction of a second.

The raster pattern can be generated by a computer using a standard X-Y grid corresponding to points on the medium. The grid has a density sufficient to allow writing to all necessary points on the medium. The steering mechanism, in turn, directs the ion beam to the points on the medium corresponding to data points on the grid, where a pulse is emitted. A simple raster controller in this type of system can be similar to the controller used in cathode ray tubes (CRTs).

Alternatively, the raster pattern can be set to follow a data track, such as a spiral. The steering coils are energized in such a way that the ion beam moves along the data track, the ion beam pulsing at selected points along the data track. In this type of system, for example, the field emitted by the steering coils in the X and Y directions can follow generally sinusoidal curves where the amplitudes of the curves gradually increase as the beam moves from the inner diameter of the media to its periphery along a spiral data track.

As mentioned above, the surface features are created by ion beam pulses. In most ion guns, including those available from Kimball Physics, the ion beam may be turned off and on while the gun is running. The way this is accomplished depends on the particular gun design. Often several beam pulsing methods are available for a particular gun.

Pulsing includes stopping and starting the flow of ions in a fast cycle. This pulsing is usually accomplished by rapidly switching the grid voltage to its cut off potential to stop the beam. The grid provides the first control over the beam and usually can be used to shut off the beam. In an ion gun, if the grid voltage is sufficiently negative with respect to the cathode, it will suppress the emission of the ions, first from the edge of the cathode and at higher (more negative) voltages from the entire cathode surface. The minimum voltage required to completely shut off the flow of ions to the target is called the grid cut off. The grid voltage can be controlled by the controller manipulating the power supply; thus, in most guns, the beam can be turned off while the gun is running by setting the grid to the cut off voltage.

The grid voltage can be controlled by several different methods, one being capacitive. Many guns can be equipped with a capacitor-containing device (either a separate pulse junction box or cylinder, or a cable with a box) that receives a signal from an external pulse generator (available from the gun manufacturer). The grid power supply and pulse generator outputs are superimposed to produce the voltage at the grid aperture. The general pattern of the beam pulsing is a square wave with a variable width (time off and time on) and a variable repetition rate. Capacitive pulsing can provide the fastest rise/fall time and shortest pulse length of the various methods. However, the capacitor does not permit long pulses or DC operation. If there is a separate grid lead on the gun, this capacitive pulsing option can be added to most existing gun systems without modification.

A typical pulse length is ˜20-100 nanoseconds, defined as the time the beam is on, measured as the width at 50% of full beam and may include some ringing. The rise/fall time is typically ˜10 nanoseconds measured between 10% and 90% of full beam. Shortening the rise-fall will typically increase ringing. Pulsing performance may also depend on the performance of the user-supplied pulse generator.

Not all guns are designed to be pulsed. For example, a few ion guns have a positive grid in order to extract more ions, and so these guns do not usually have grid cut off, unless a dual grid supply is ordered. In some high-current ion guns, the optical design, the position of the cathode, does not allow for cut-off with the grid, and so a different option, called blanking, must be used to interrupt the beam instead of pulsing.

Beam blanking deflects the ion beam to one side of the ion gun tube to interrupt the flow of ions to the target without actually turning off the beam. The voltage applied to the blanker plate in the gun is controlled by a potentiometer on the power supply. Blanking can be used to pulse the final beam current repeatedly on and off in response to a TTL signal input. The blanker voltage required for beam cutoff depends on the gun configuration and on the beam energy, and can be readily determined from the reference materials accompanying the ion gun from the manufacturer.

As mentioned above, the system 500 can write data to commercially available media, recordable media, and specialty media. How the system 500 writes data to commercially available media such as CDs and DVDs will be discussed first.

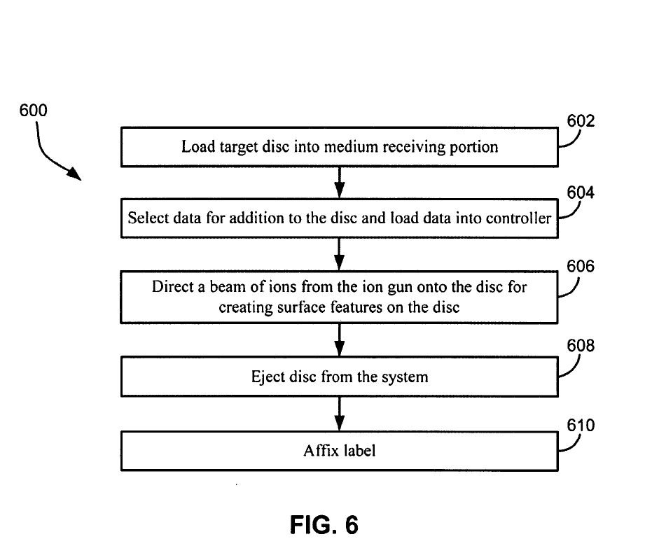

FIG. 6 depicts a method 600 for writing data to a standard CD or a single or double sided, single layer (per side) DVD. In operation 602, the target disc is loaded into the medium receiving portion either manually or by an automated system. The medium receiving portion preferably holds the target disc in a fixed position so that movement is eliminated.

As mentioned above, a CD and DVD typically comprises a clear polycarbonate plastic underlayer, a thin, reflective aluminum layer sputtered onto the polycarbonate, and a thin protective layer, e.g., acrylic, lacquer, etc. sprayed over the aluminum to protect it. In this method 600, the target disc as loaded into the system comprises polycarbonate, a reflective layer, and acrylic backing. The acrylic backing faces the ion gun. In operation 604, data is selected for addition to the disc and loaded into the controller. In operation 606, under control of the controller, a beam of ions from the ion gun is directed onto the disc for creating surface features on the disc. The ion beam is caused to pulse intermittently in a controlled manner to create the surface features along the data track, the surface features representing data in a data track. The resulting data track is a spiral pattern starting from the inner diameter of the disc. The power of the ion beam is set such that it will pierce the backing layer and create optically discernable features on the reflective layer so that the reader will only detect reflections from the nonexposed parts of the reflective layer, thereby creating surface features along the data track. For a CD, the data points are about 0.5 microns (500 nanometers) wide, and a minimum of 0.83 (830 nanometers) microns long. The track spacing is about 6 microns (6000 nanometers). In a DVD, the damaged sections of the reflective layer that make up the data track are each about 320 nanometers wide and a minimum of 400 nanometers long. The track spacing is about 740 nanometers.

In operation 608, the disc is ejected from the system. In operation 610, a label is then printed onto the acrylic using a printing device known in the art, or affixed as an adhesive layer. In this way, the damaged area of the disc is covered and is nonapparent to the end user. The side of the label adjacent the disc is preferably nonreflective so as not to reflect the reader's laser during playback. Also note that a protective layer can optionally be added prior to affixing the label.

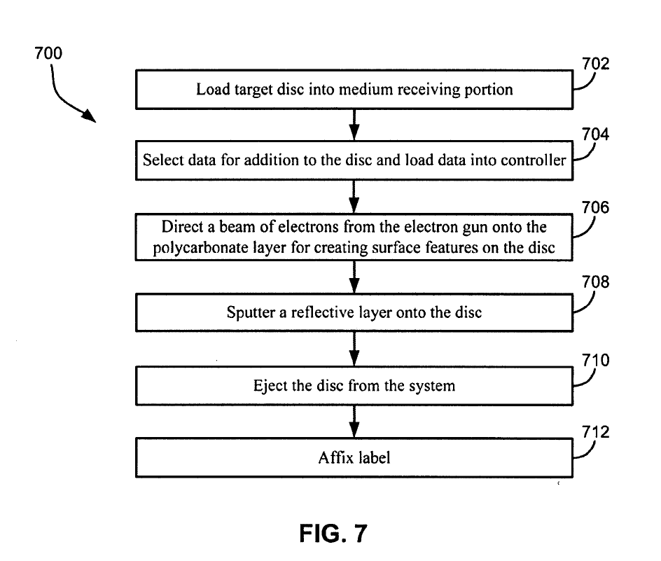

FIG. 7 depicts a method 700 for writing data to a CD or a single or double sided, single layer (per side) DVD. In this method, the disc comprises a substantially transparent polycarbonate layer as loaded into the medium receiving portion. Note operation 702. In operation 704, data is selected for addition to the disc and loaded into the controller. In operation 706, under control of the controller, intermittent pulses of a beam of ions from the ion gun are directed onto the polycarbonate layer for creating surface features on the disc, the surface features representing data in a data track. The power of the ion beam is set such that it creates pits in the polycarbonate layer. For a CD, the pits are set at about 125 nanometers deep. For a DVD, the pits are set at about 120 nanometers deep.

Again, the ion beam is pulsed in a controlled manner to create the surface features along the data track. For a CD, the pits are about 0.5 microns (500 nanometers) wide, and a minimum of 0.83 (830 nanometers) microns long. The track spacing is about 6 microns (6000 nanometers). In a DVD, the pits are each about 320 nanometers wide, a minimum of 400 nanometers long. The track spacing is about 740 nanometers.

In operation 708, a reflective layer is sputtered onto the disc. In operation 710, the disc is ejected from the system. In operation 712, a label is then printed onto the acrylic using a printing device known in the art, or affixed as an adhesive layer.

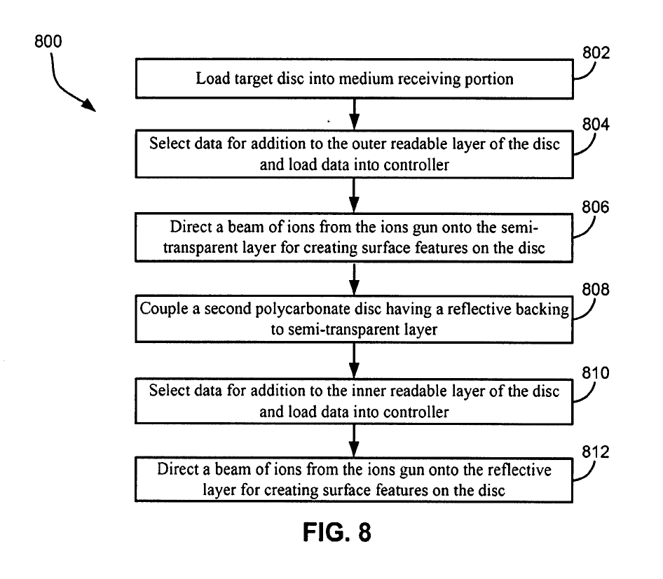

FIG. 8 depicts a method 800 for writing data to a single sided, double layer (per side) DVD. In this method, a first substantially transparent polycarbonate layer having a semi-transparent layer, preferably of gold, is loaded into the medium receiving portion. Note operation 802. This is the outer readable layer. The semi-transparent layer faces the ion gun. In operation 804, data is selected for addition to the outer readable layer of the disc and loaded into the controller. In operation 806, under control of the controller, intermittent pulses of a beam of ions from the ion gun are directed onto the semi-transparent layer for creating surface features on the disc, the surface features representing data in a data track that is readable as the outer data track. In operation 808, a second polycarbonate disc having a reflective backing is coupled to the semi-transparent layer. The reflective backing faces the ion gun.

In operation 810, data is selected for addition to the inner readable layer of the disc and loaded into the controller. In operation 812, under control of the controller, intermittent pulses of a beam of ions from the ion gun are directed onto the reflective layer for creating surface features on the disc, the surface features representing data in a data track that is readable as the inner data track. Then additional steps, such as adding an acrylic backing and label can be performed.

This method 800 has the advantage that the disc does not move, and the ion gun does not move. Thus, the inner and outer readable layers are inherently aligned perfectly every time.

The process can be repeated to create two additional data layers which can be coupled to the first and second polycarbonate discs, thereby creating a dual side, double layer DVD. The process can even be used to make media having more than two readable layers on each side, e.g., 3, 4, 5, 6 layers per side.

Likewise, the method of 700, where the transparent layers are modified by the ion beam, can be adapted to create multi-level optical media, as will be apparent to one skilled in the art. In this situation, the transparent layer of the outer readable layer is first written to, and a semi-transparent layer is sputtered onto it. A second transparent layer (inner readable layer) is coupled to the semi-transparent layer and data written thereto. A reflective layer is then sputtered onto the second transparent layer followed by labeling or addition of other layers.

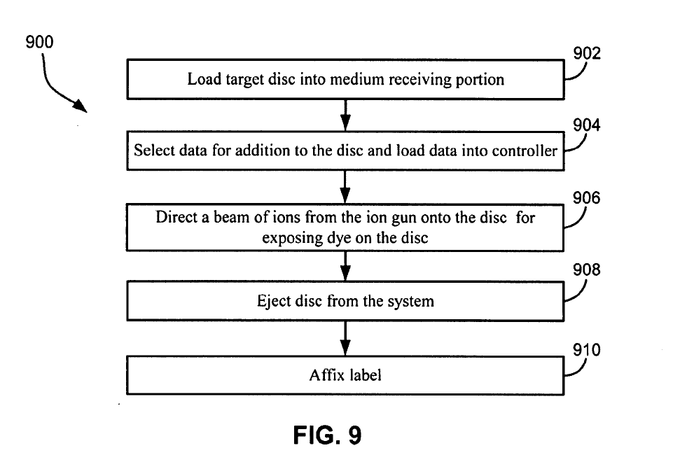

FIG. 9 depicts a method 900 for writing data to a recordable disc, such as a commercially available recordable CD or DVD. In this method, the disc comprises a substantially transparent layer, a dye layer, and a reflective layer as loaded into the medium receiving portion, the reflective layer facing the ion gun. Note operation 902. In operation 904, data is selected for addition to the disc and loaded into the controller. In operation 906, under control of the controller, intermittent pulses of a beam of ions from the ion gun are directed onto the disc for exposing the dye in the dye layer. The exposed dye darkens, thereby creating surface features representing data in a data track. The power of the ion beam is preferably set such that it pierces the reflective layer and exposes the dye, but does not significantly damage the underlying transparent layer. Again, the ion beam is pulsed in a controlled manner to create the surface features along the data track. In operation 908, the disc is ejected from the system. In operation 910, a label is then printed onto the acrylic using a printing device known in the art, or affixed as an adhesive layer. In a variation, the dye layer is substantially nontransparent in an unexposed state, the ion pulses creating substantially transparent portions of the dye layer.

This method can also be used to write to rewritable discs, e.g., CD-RW and DVD±RW. In that case, the power of the ion beam is set to heat areas of the phase-change material above the melting temperature (500-700° C.), so all the atoms in this area can move rapidly in the liquid state. Then, if cooled sufficiently quickly, the random liquid state is “frozen-in” and the so-called amorphous state is obtained. The amorphous version of the material is opaque, creating an equivalent to a “pit” where the data point was written by the ion beam, resulting in a recognizable CD or DVD surface.

One skilled in the art will appreciate that the various operations of the methods described above can be combined to create additional methods for writing data to optical media, such additional method being considered within the scope of the present invention. One skilled in the art will also appreciate that the methods can be adapted with software instructions to write to types of media other than disc shaped media.

In any of these methods, the surface features can be made significantly smaller than has heretofore been possible, even using commercially available media. This is due to the fine detail (e.g., ˜5 nanometer) and sharp edges afforded by ion beam theology. For instance, the surface features can have a length along a data track thereof of less than about 500 nanometers, less than about 200 nanometers, less than about 100 nanometers, and less than about 50 nanometers. In this way, the data storable on a single medium can be greatly improved, limited only by the wavelength of the optical system used. For discs having surface features finer than a DVD, a reader capable of reading finer-than-DVD features is used. For even finer surface features, for example, ultraviolet, microwave and x-ray optical systems may be required.

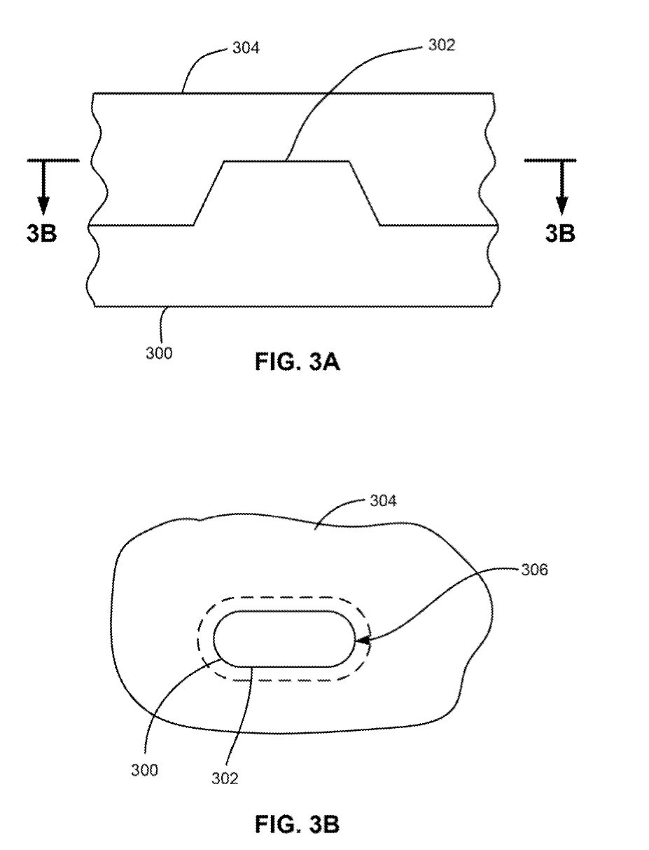

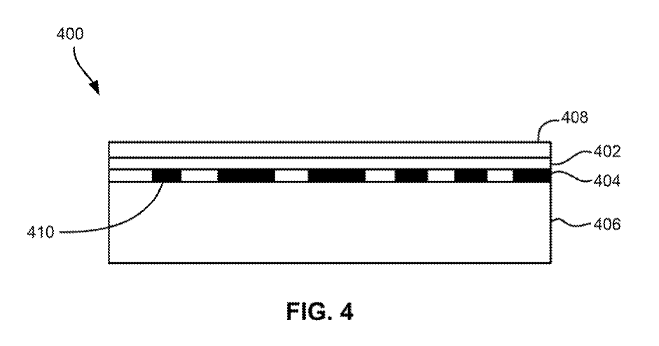

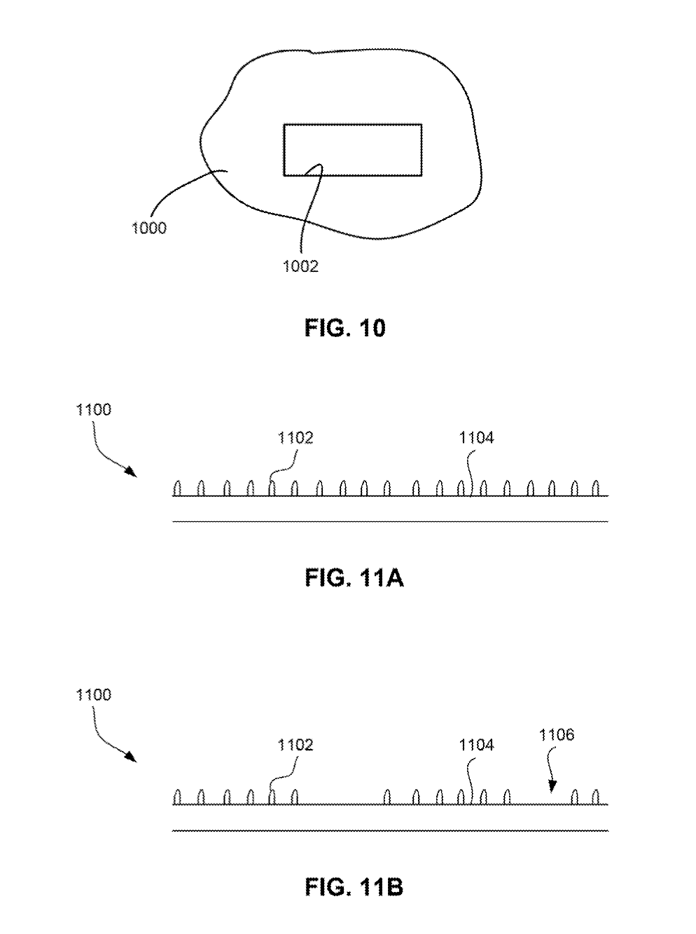

Also note that the surface features created can have almost perfectly straight edges. FIG. 10 illustrates a surface of a media 1000 formed as above having a surface feature 1002 formed by an ion beam. Comparing the media 1000 in FIG. 10 to FIG. 3B, it is seen that the ion beam-create surface features 1002 have very straight edges and sharp corners. The resultant media have been found to have much less jitter than optical media heretofore known.

In another variation, the electron beam can be used to create “pits and lands” of varying reflectivity on a surface having nanofeatures that affect the reflectivity of light. The shapes and number of the nanofeatures determine the amount of reflectivity (if any) of the surface. Thus, a separate reflective layer is not needed. Those skilled in the art will appreciate that the shape and size of the nanofeatures can vary, and will be able to select a shape and size without undue experimentation.

FIG. 11A shows an illustrative media layer 1100 having a data area covered with nanofeatures 1102. The layer 1100 can be created with the nanofeatures so that it begins life in a substantially nonreflective state. Or the nanofeatures 1102 can be created on a reflective surface by stamping, molding, etc. To write to the media, the ion beam melts or oblates the nanofeatures 1102, creating or exposing reflective areas 1106 on the surface 1104. This is shown in FIG. 11B. Thus “pits and lands” are created, which can be read by measuring the change in reflectivity as the laser reads the media.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. An optical medium, comprising:
an underlayer; and
a reflective layer,
wherein at least one of the underlayer and the reflective layer has surface features, the surface features affecting reflectivity of light emitted thereagainst in a manner that represents data,
the surface features having been formed by directing pulses of a beam of ions from an ion source onto at least one of the underlayer and the reflective layer in a controlled pattern for creating the surface features.

2. The optical medium as recited in claim 1, wherein the pattern has a generally spiral shape.

3. The optical medium as recited in claim 1, wherein the optical medium is readable by at least one of a consumer-grade digital video disc (DVD) player and a consumer-grade compact disc (CD) player.

4. The optical medium as recited in claim 1, wherein the optical medium is readable by a reader capable of reading surface features finer than a consumer-grade digital video disc (DVD) player.

5. The optical medium as recited in claim 1, wherein the optical medium is selected from a group consisting of a commercially available compact disc, a commercially available digital video disc, a commercially available writable compact disc, a commercially available writable digital video disc, and a commercially available writable optical medium.

6. The optical medium as recited in claim 1, wherein the ion pulses modify the underlayer.

7. The optical medium as recited in claim 1, wherein the ion pulses modify the reflective layer.

8. The optical medium as recited in claim 1, wherein the ion pulses have created pits in the underlayer, the reflective layer having been added after the surface features are created.

9. The optical medium as recited in claim 1, wherein the underlayer is a dye layer being substantially transparent in an unexposed state, the ion pulses creating darkened portions of the dye layer.

10. The optical medium as recited in claim 1, wherein the underlayer is a dye layer being substantially nontransparent in an unexposed state, the ion pulses creating substantially transparent portions of the dye layer.

11. The optical medium as recited in claim 1, further comprising multiple underlayers and multiple reflective layers.

12. The optical medium as recited in claim 11, wherein the multiple underlayers and multiple reflective layers are present on a same readable side of the optical medium.

13. The optical medium as recited in claim 11, wherein the underlayers are positioned on opposite sides of the optical medium, wherein the reflective layers are positioned on opposite sides of the optical medium.

14. The optical medium as recited in claim 1, wherein the surface features have a length along a data track thereof of less than about 500 nanometers.

15. The optical medium as recited in claim 1, wherein the surface features have a length along a data track thereof of less than about 200 nanometers.

16. The optical medium as recited in claim 1, wherein the surface features have a length along a data track thereof of less than about 100 nanometers.

17. The optical medium as recited in claim 1, wherein the surface features are created on at least two layers of the optical medium.

18. The optical medium as recited in claim 1, wherein the data has been written to the optical medium in less than about one minute.

19. The optical medium as recited in claim 1, wherein the data has been written to the optical medium in less than about one second.

20. The optical medium as recited in claim 1, wherein the data includes at least one of audio data, video data and software.

21. An optical medium, comprising:
a disc-shaped underlayer; and
a disc-shaped reflective layer,
wherein at least one of the underlayer and the reflective layer has surface features thereon representing data, the surface features having been formed by directing pulses of a beam of ions from an ion source onto at least one of the underlayer and the reflective layer in a controlled pattern for creating the surface features.

22. An optical medium, comprising:
a surface having first portions being reflective and second portions with nanofeatures that affect reflectivity of light emitted thereagainst, the first and second portions on the surface representing data.

23. The optical medium as recited in claim 22, wherein the first and second portions of the surface have been defined by an ion beam.
